(19) United States
(12) Patent Application Publication
(10) Pub. No.: US 2026/0230583 A1
(43) Pub. Date: Aug. 6, 2026

(54) METAVERSE SPACE DISPLAY DEVICE, METAVERSE SPACE DISPLAY METHOD, AND RECORDING MEDIUM

(71) Applicant: NEC Corporation, Tokyo (JP)

(72) Inventor: Keisuke KANEYASU, Tokyo (JP)

(73) Assignee: NEC Corporation, Tokyo (JP)

(21) Appl. No.: 19/146,278

(22) PCT Filed: Mar. 29, 2023
(86) PCT No.: PCT/JP2023/012848

§ 371 Date: Jul. 8, 2025

(51) Int. Cl. H04N 7/15; G06T 19/00

(52) U.S. Cl. CPC H04N 7/157; G06T 19/00

(57) ABSTRACT

In the metaverse space display device, the first display means displays a two-dimensional metaverse space including a two-dimensional avatar and a two-dimensional virtual object. The second display means displays a three-dimensional metaverse space including a three-dimensional avatar and a three-dimensional virtual object. The reception means receives an operation from a user. The display control means performs switching to the display by the first display means or the display by the second display means based on a content of the operation.

### TECHNICAL FIELD

The present disclosure relates to display control of a metaverse space.

### BACKGROUND ART

In recent years, a metaverse space is becoming more and more prevalent, and a plurality of users can interact with each other on a network as in a real world. The metaverse space is configured two-dimensionally or three-dimensionally, and in a three-dimensional metaverse space, an avatar or an object can be accurately represented, but many computer resources are required. Therefore, it is difficult for a computer to continuously allocate the computer resources to the three-dimensional metaverse space while executing another piece of software. Patent Document 1 proposes provision of a virtual space system in which loads of both network resources and end system resources are taken into consideration.

### PRECEDING TECHNICAL REFERENCE PATENT DOCUMENT Patent Document 1: JP 2002-063598 A

### SUMMARY PROBLEM TO BE SOLVED

However, even with Patent Document 1, it is not always possible to appropriately allocate the computer resources while using the metaverse space.

It is an example object of the present disclosure to provide a metaverse space display device capable of appropriately allocating computer resources by performing display control of a metaverse space.

### MEANS FOR SOLVING THE PROBLEM

According to an example aspect of the present disclosure, there is provided a metaverse space display device, comprising:
first display means for displaying a two-dimensional metaverse space including a two-dimensional avatar and a two-dimensional virtual object;
second display means for displaying a three-dimensional metaverse space including a three-dimensional avatar and a three-dimensional virtual object;
reception means for receiving an operation from a user; and display control means for performing switching to the display by the first display means or the display by the second display means based on a content of the operation,
the first display means displaying an avatar of a user who is not logged in to the metaverse space in a mode different from a mode of an avatar of a user who is logged in to the metaverse space.

According to another example aspect of the present disclosure, there is provided a metaverse space display method comprising:
performing first display processing of displaying a two-dimensional metaverse space including a two-dimensional avatar and a two-dimensional virtual object;
performing second display processing of displaying a three-dimensional metaverse space including a three-dimensional avatar and a three-dimensional virtual object;
receiving an operation from a user; and
performing switching to the display by the first display processing or the display by the second display processing based on a content of the operation,
an avatar of a user who is not logged in to the metaverse space being displayed in the first display processing in a mode different from a mode of an avatar of a user who is logged in to the metaverse space.

According to a further example aspect of the present disclosure, there is provided a recording medium recording a program for causing a computer to execute processing comprising:
performing first display processing of displaying a two-dimensional metaverse space including a two-dimensional avatar and a two-dimensional virtual object;
performing second display processing of displaying a three-dimensional metaverse space including a three-dimensional avatar and a three-dimensional virtual object;
receiving an operation from a user; and
performing switching to the display by the first display processing or the display by the second display processing based on a content of the operation,
an avatar of a user who is not logged in to the metaverse space being displayed in the first display processing in a mode different from a mode of an avatar of a user who is logged in to the metaverse space.

### EFFECT

According to the present disclosure, it is possible to appropriately allocate computer resources by performing display control of a metaverse space.

### BRIEF DESCRIPTION OF THE DRAWINGS

FIG. 1 illustrates an overall configuration of a metaverse space management system according to a first example embodiment.

FIG. 2 is a block diagram illustrating a configuration of a server according to the first example embodiment.

FIG. 3 is a block diagram illustrating a functional configuration of the server according to the first example embodiment.

FIG. 4(A) and 4(B) are display examples of a metaverse space according to the first example embodiment.

FIG. 5 is a flowchart of metaverse space control processing according to the first example embodiment.

FIG. 6 is a block diagram illustrating a functional configuration of a server according to a second example embodiment.

FIG. 7(A) and 7(B) are display examples of a metaverse space according to the second example embodiment.

FIG. 8 is a flowchart of metaverse space control processing according to the second example embodiment.

FIG. 9 is a block diagram illustrating a functional configuration of a metaverse space display device of a third example embodiment.

FIG. 10 is a flowchart of processing by the metaverse space display device of the third example embodiment.

### EXAMPLE EMBODIMENTS

Hereinafter, preferred example embodiments of the present disclosure will be described with reference to the drawings.

### First Example Embodiment

### System Configuration

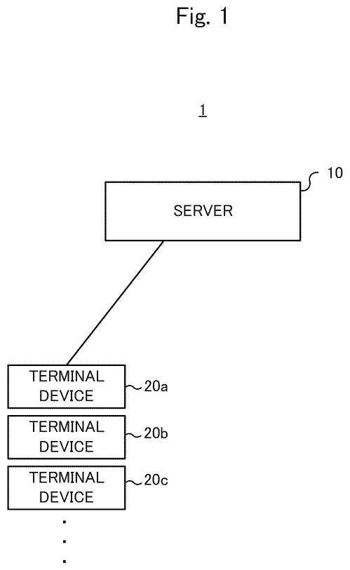

FIG. 1 illustrates an overall configuration of a metaverse space management system to which a metaverse space display device according to the present disclosure is applied. A metaverse space management system 1 includes a server 10 and terminal devices 20 used by users. The server 10 is an example of the metaverse space display device.

It is assumed that there is the plurality of terminal devices 20, and subscripts are added to the terminal devices 20 when the individual terminal devices are distinguished, and the plurality of terminal devices 20 is simply referred to as the “terminal devices 20” when not being distinguished. The server 10 and the terminal devices 20 can communicate with each other in a wired or wireless manner.

In the metaverse space management system 1, by the server 10 transmitting data of a metaverse space to the terminal devices 20 in response to requests of the terminal devices 20, a place for communication among users is provided. In the present example embodiment, a virtual office as a virtual office space will be described as an example of the metaverse space provided by the metaverse space management system 1, but the metaverse space provided by the metaverse space management system 1 is not limited to this, and may be any metaverse space as long as it provides the place for the communication among the users.

Specifically, the server 10 draws virtual objects such as a desk, a chair, and a meeting room according to setting information prepared in advance, and generates data of the virtual office. When a user accesses the server 10 using the terminal device 20 and logs in to the virtual office, the server 10 generates an avatar based on login information regarding the user and arranges the avatar in the virtual office. The server 10 then transmits the data of the virtual office to the terminal device 20.

The terminal device 20 is a terminal device such as a personal computer (PC) or a tablet. The user of the terminal device 20 acquires the data of the virtual office and displays the data on a display or the like, in such a way that the user can experience that the user is in the virtual office. The user can move his/her own avatar or communicate with an avatar of another user by operating his/her own avatar by using the terminal device 20.

The server 10 of the present example embodiment further generates a two-dimensional virtual office and a three-dimensional virtual office, and transmits data of the two-dimensional virtual office or data of the three-dimensional virtual office to the terminal device 20 based on an operation of the user. The user can switch display of the virtual office according to application, such as displaying the three-dimensional virtual office when sharing the three-dimensional data and displaying the two-dimensional virtual office when not sharing the three-dimensional data. With this arrangement, the user can appropriately allocate computer resources.

### Hardware Configuration

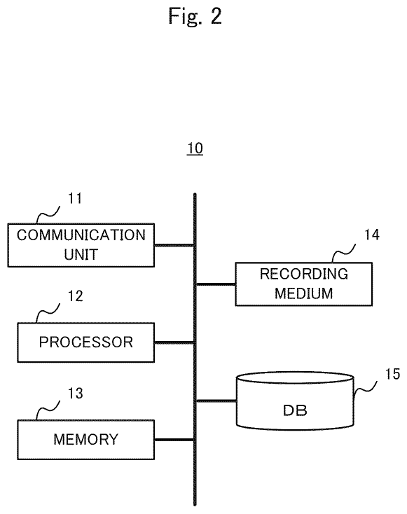

FIG. 2 is a block diagram illustrating a hardware configuration of the server 10. The server 10 mainly includes a communication unit 11, a processor 12, a memory 13, a recording medium 14, and a database (DB) 15.

The communication unit 11 transmits and receives data to and from an external device. Specifically, the communication unit 11 transmits and receives information to and from the terminal device 20.

The processor 12 is a computer such as a central processing unit (CPU), and controls the entire server 10 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used.

The memory 13 includes a read only memory (ROM), a random access memory (RAM), and the like. The memory 13 stores various programs executed by the processor 12. The memory 13 is also used as a work memory during execution of various types of processing by the processor 12.

The recording medium 14 is a non-volatile non-transitory recording medium such as a disk-shaped recording medium or a semiconductor memory, and is attachable to and detachable from the server 10. The recording medium 14 records various programs executed by the processor 12.

The database (DB) 15 stores information regarding a user, information regarding a metaverse space, and the like. The information regarding the user includes, for example, identification information for uniquely identifying the user, avatar setting information, and the like. The information regarding the metaverse space includes, for example, information such as coordinates and a display form of a virtual object. The DB 15 may include an external storage device such as a hard disk connected to or built in the server 10, or may include a storage medium such as a freely attachable and detachable flash memory. Instead of providing the DB 15 in the server 10, the DB 15 may be provided in an external server or the like, and the information regarding the user, the information regarding the metaverse space, and the like may be stored in the server by communication.

The server 10 may include an input unit such as a keyboard and a mouse for an administrator or the like to perform instruction and input, and a display unit such as a liquid crystal display.

### Functional Configuration

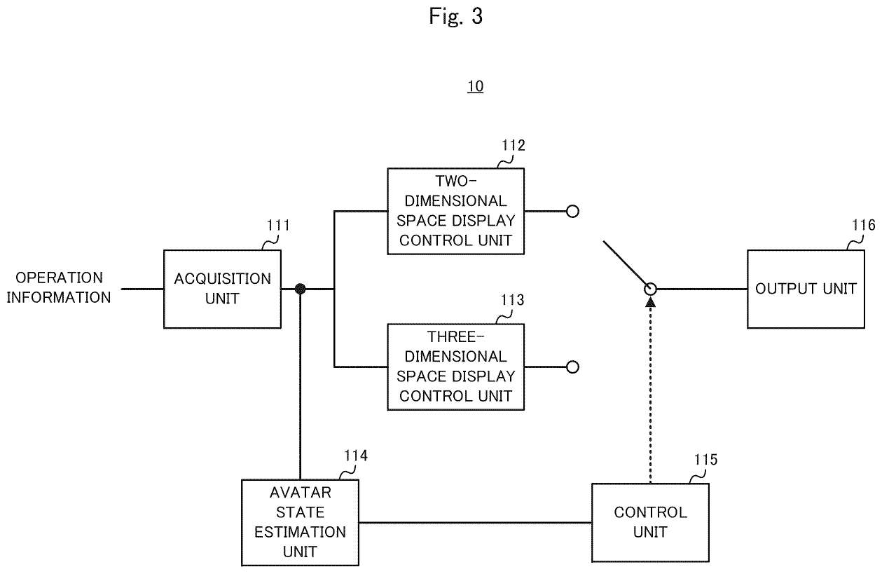

FIG. 3 is a block diagram illustrating a functional configuration of the server 10 according to the first example embodiment. The server 10 functionally includes an acquisition unit 111, a two-dimensional space display control unit 112, a three-dimensional space display control unit 113, an avatar state estimation unit 114, a control unit 115, and an output unit 116.

The server 10 receives operation information from the terminal device 20 through the communication unit 11. The acquisition unit 111 acquires the operation information for each user, and outputs the operation information to the two-dimensional space display control unit 112, the three-dimensional space display control unit 113, and the avatar state estimation unit 114.

The operation information is information regarding an operation executed by a user in a virtual office. The operation information includes information regarding a login operation to the virtual office, information regarding an operation performed on an avatar, and the like.

The two-dimensional space display control unit 112 generates a two-dimensional virtual office. The two-dimensional space display control unit 112 draws an avatar based on the operation information input from the acquisition unit 111.

Specifically, in a case where the user logs in to the virtual office, the two-dimensional space display control unit 112 draws an avatar of the user in a mode indicating a login state. On the other hand, in a case where the user logs out of the virtual office, the two-dimensional space display control unit 112 draws the avatar of the user in a mode indicating a logout state.

When the user performs a movement operation on the avatar, the two-dimensional space display control unit 112 updates a position of the avatar according to the operation of the user. For example, the two-dimensional space display control unit 112 obtains a movement amount of the avatar based on a movement direction, a speed, and the like of the avatar, and estimates the position of the avatar after the movement.

The two-dimensional space display control unit 112 then moves the avatar from the current position to the position after the movement.

The three-dimensional space display control unit 113 generates a three-dimensional virtual office. The three-dimensional space display control unit 113 draws an avatar based on the operation information input from the acquisition unit 111.

Specifically, when the user performs a movement operation on the avatar, the three-dimensional space display control unit 113 obtains a movement amount of the avatar based on a movement direction, a speed, and the like of the avatar, and estimates a position of the avatar after the movement. The three-dimensional space display control unit 113 then determines whether the position of the avatar after the movement is included in a predetermined area (hereinafter, also referred to as a “three-dimensional area”) determined in advance. In a case where it is determined that the avatar is included in the three-dimensional area, the three-dimensional space display control unit 113 draws the avatar in the three-dimensional area. In a case where the avatar moves from the three-dimensional area to an area other than the three-dimensional area (hereinafter, also referred to as a “two-dimensional area”) or in a case where the user logs out of the virtual office, the three-dimensional space display control unit 113 deletes the avatar from the three-dimensional area.

The avatar state estimation unit 114 estimates the position of the avatar based on the operation information input from the acquisition unit 111. The avatar state estimation unit 114 then outputs the estimated position of the avatar to the control unit 115 together with identification information regarding the user related to the avatar.

Here, the position of the avatar estimated by the avatar state estimation unit 114 is only required to be information indicating whether the avatar is positioned in the two-dimensional area or the three-dimensional area. For example, in a case where it is determined that a certain avatar has moved from the two-dimensional area to the three-dimensional area, the avatar state estimation unit 114 sets a position of the avatar as in the “three-dimensional area” and outputs the position to the control unit 115. On the other hand, in a case where it is determined that a certain avatar has moved from the three-dimensional area to the two-dimensional area, the avatar state estimation unit 114 sets a position of the avatar as in the “two-dimensional area” and outputs the position to the control unit 115.

The control unit 115 switches between the two-dimensional space display control unit 112 and the three-dimensional space display control unit 113 for each user based on the position of the avatar input from the avatar state estimation unit 114 and the identification information regarding the user related to the avatar. For example, in a case where the avatar is positioned in the two-dimensional area, the control unit 115 performs switching in such a way that the output unit 116 is connected to the two-dimensional space display control unit 112. In a case where the avatar is positioned in the three-dimensional area, the control unit 115 performs switching in such a way that the output unit 116 is connected to the three-dimensional space display control unit 113.

The display control unit connected to the output unit 16 then outputs display data to the output unit 116.

The output unit 116 acquires the display data from the connected display control unit. The output unit 116 then transmits the display data to the terminal device 20.

In the above configuration, the acquisition unit 111 is an example of reception means, the two-dimensional space display control unit 112 is an example of first display means, the three-dimensional space display control unit 113 is an example of second display means, and the avatar state estimation unit 114, the control unit 115, and the output unit 116 are examples of display control means.

### Display Example

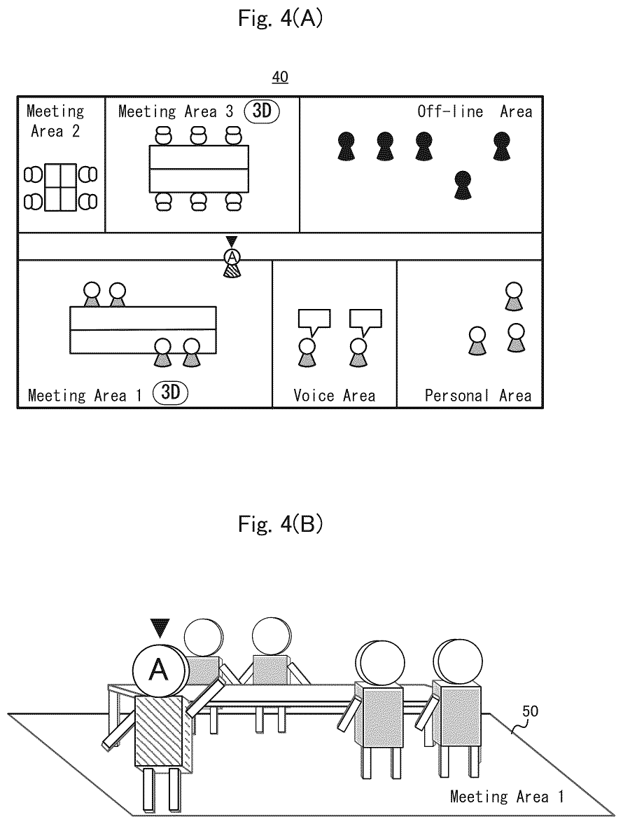

FIG. 4(A) and 4(B) illustrate display examples of the virtual office transmitted by the server 10.

FIG. 4(A) is an example of display of the two-dimensional virtual office. In a virtual office 40 of FIG. 4(A), a plurality of areas such as a “Meeting Area”, a “Personal Area”, a “Voice Area”, and an “Off-Line Area” according to applications is provided.

The “Meeting Area” is an area where a plurality of avatars perform cooperative work such as a meeting. The “Personal Area” is an area where avatars of users who are performing personal work gather. The “Voice Area” is an area used in a case where avatars have a voice conversation, and the like.

In the “Off-Line Area”, an avatar of a user who has logged out of the virtual office is displayed. The avatar of the user who has logged out (hereinafter, also referred to as a “logout avatar”) is displayed in a different display mode from an avatar of a user who has logged in (hereinafter, also referred to as a “login avatar”). For example, in FIG. 4(A), the logout avatars are displayed in black. The login avatar can talk to the logout avatar by using a function such as chat. At this time, the server 10 may perform notification to a user related to the avatar that has been talked to. For example, the server 10 can perform the notification to the terminal device 20, a smartphone, a wearable terminal, or the like owned by the user.

The virtual office 40 is provided with the three “Meeting Areas”, and a 3D mark indicating the three-dimensional area is displayed in “Meeting Area 1” and “Meeting Area 3”.

Now, it is assumed that a user related to an avatar A has moved the avatar A to “Meeting Area 1”. As a result, a three-dimensional virtual office as illustrated in FIG. 4(B) is displayed on the terminal device 20 of the user related to the avatar A.

FIG. 4(B) is an example of display of the three-dimensional virtual office. In FIG. 4(B), the avatar A, other avatars, and a virtual object are three-dimensionally displayed in a meeting area 50. With such display, the user can share accurate data such as three-dimensional data. The user can also have a conversation with a feeling close to reality through the avatar.

### Metaverse Space Control Processing

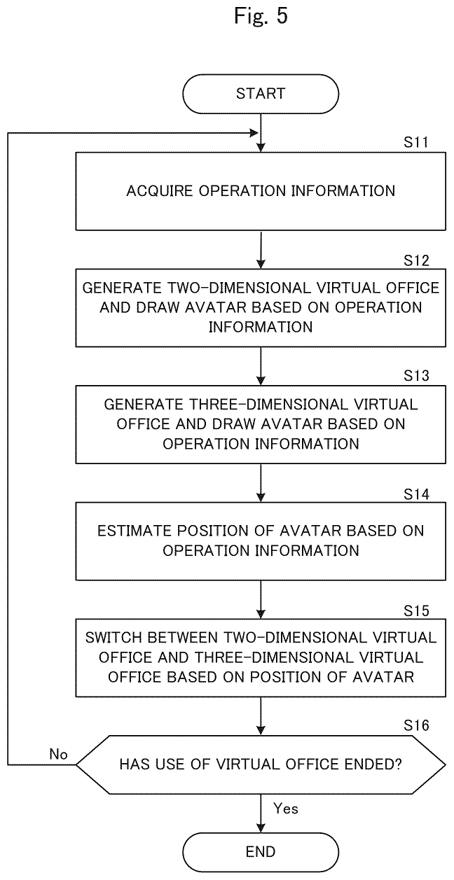

Next, metaverse space control processing of controlling a metaverse space as described above will be described. FIG. 5 is a flowchart of the metaverse space control processing by the server 10. This processing is achieved by the processor 12 illustrated in FIG. 2 executing a program prepared in advance and operating as each element illustrated in FIG. 3.

First, the server 10 receives operation information from the terminal device 20 through the communication unit 11. The acquisition unit 111 acquires the operation information for each user, and outputs the operation information to the two-dimensional space display control unit 112, the three-dimensional space display control unit 113, and the avatar state estimation unit 114 (step S11).

Next, the two-dimensional space display control unit 112 generates a two-dimensional virtual office. The two-dimensional space display control unit 112 draws an avatar based on the operation information input from the acquisition unit 111 (step S12). Next, the three-dimensional space display control unit 113 generates a three-dimensional virtual office. The three-dimensional space display control unit 113 draws an avatar based on the operation information input from the acquisition unit 111 (step S13).

Next, the avatar state estimation unit 114 estimates a position of the avatar based on the operation information input from the acquisition unit 111. The avatar state estimation unit 114 then outputs the estimated position of the avatar to the control unit 115 together with identification information regarding a user related to the avatar (step S14). The position of the avatar estimated by the avatar state estimation unit 114 is only required to be information indicating whether the avatar is positioned in a two-dimensional area or a three-dimensional area.

Next, the control unit 115 switches between the two-dimensional space display control unit 112 and the three-dimensional space display control unit 113 for each user based on the position of the avatar input from the avatar state estimation unit 114 and the identification information regarding the user related to the avatar (step S15).

Next, in a case where the server 10 determines that the user has logged out of the virtual office and use of the virtual office has ended (step S16: Yes), the processing ends. On the other hand, in a case where the server 10 determines that the use of the virtual office has not ended (Step S16: No), the processing returns to step S11.

### Second Example Embodiment

Next, a second example embodiment will be described. A server 10a as a metaverse space display device of the second example embodiment is different from the server 10 of the first example embodiment in that display between a two-dimensional virtual office and a three-dimensional virtual office can be switched regardless of a position of an avatar. The server 10a according to the second example embodiment has a system configuration and a hardware configuration similar to those in the first example embodiment, and thus description thereof will be omitted.

### Functional Configuration

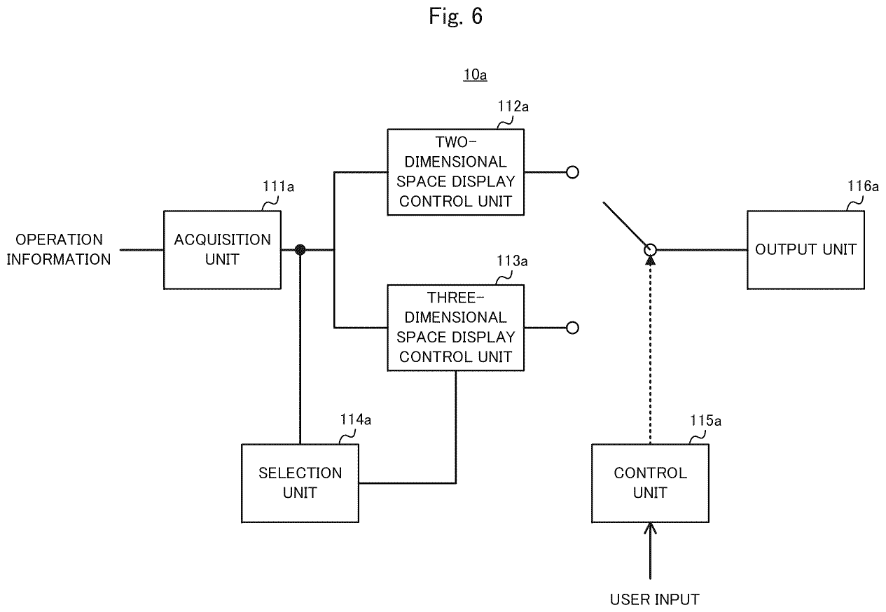

FIG. 6 is a block diagram illustrating a functional configuration of the server 10a according to the second example embodiment. The server 10a functionally includes an acquisition unit 111a, a two-dimensional space display control unit 112a, a three-dimensional space display control unit 113a, a selection unit 114a, a control unit 115a, and an output unit 116a.

The two-dimensional space display control unit 112a and the output unit 116a have configurations similar to those of the two-dimensional space display control unit 112 and the output unit 116 of the server 10 according to the first example embodiment, and operate in a similar manner, and thus description thereof will be omitted.

The server 10a receives operation information from a terminal device 20 through a communication unit 11. The acquisition unit 111a acquires the operation information for each user, and outputs the operation information to the two-dimensional space display control unit 112a, the three-dimensional space display control unit 113a, and the selection unit 114a. The operation information is information regarding an operation executed by a user in a virtual office. The operation information includes information regarding a login operation to the virtual office, information regarding an operation performed on an avatar, and the like.

The selection unit 114a selects an avatar to be displayed in a three-dimensional virtual office (hereinafter, also referred to as a “three-dimensional avatar”). For example, the selection unit 114a may select an avatar of a user who is performing a predetermined operation such as a voice conversation as the three-dimensional avatar based on the operation information input from the acquisition unit 111a. The selection unit 114a may select an avatar of a user belonging to a predetermined department or an avatar of a user in a predetermined position as the three-dimensional avatar. The selection unit 114a may select an avatar of another user using the three-dimensional virtual office as the three-dimensional avatar.

The selection unit 114a outputs identification information regarding the three-dimensional avatar to the three-dimensional space display control unit 113a. The identification information regarding the three-dimensional avatar is information for uniquely identifying the avatar, and may use, for example, identification information regarding a user related to the avatar or the like.

The three-dimensional space display control unit 113a generates the three-dimensional virtual office. The three-dimensional space display control unit 113a draws an avatar based on the operation information input from the acquisition unit 111a and the identification information regarding the three-dimensional avatar input from the selection unit 114a.

Specifically, the three-dimensional space display control unit 113a draws the avatar related to the identification information in the virtual office. At this time, the three-dimensional space display control unit 113a estimates a position of the avatar based on the operation information, and draws the avatar at the estimated position. In a case where the user logs out of the virtual office, the three-dimensional space display control unit 113a deletes the corresponding avatar.

The control unit 115a switches between the two-dimensional space display control unit 112a and the three-dimensional space display control unit 113a based on an input of the user. For example, in a case where the user performs the input to display a two-dimensional virtual office through the terminal device 20, the control unit 115a performs switching in such a way that the output unit 116a is connected to the two-dimensional space display control unit 112a. In a case where the user performs the input to display the three-dimensional virtual office through the terminal device 20, the control unit 115a performs switching in such a way that the output unit 116a is connected to the three-dimensional space display control unit 113a. The display control unit selected by the control unit 115a outputs display data to the output unit 116a.

### Display Example

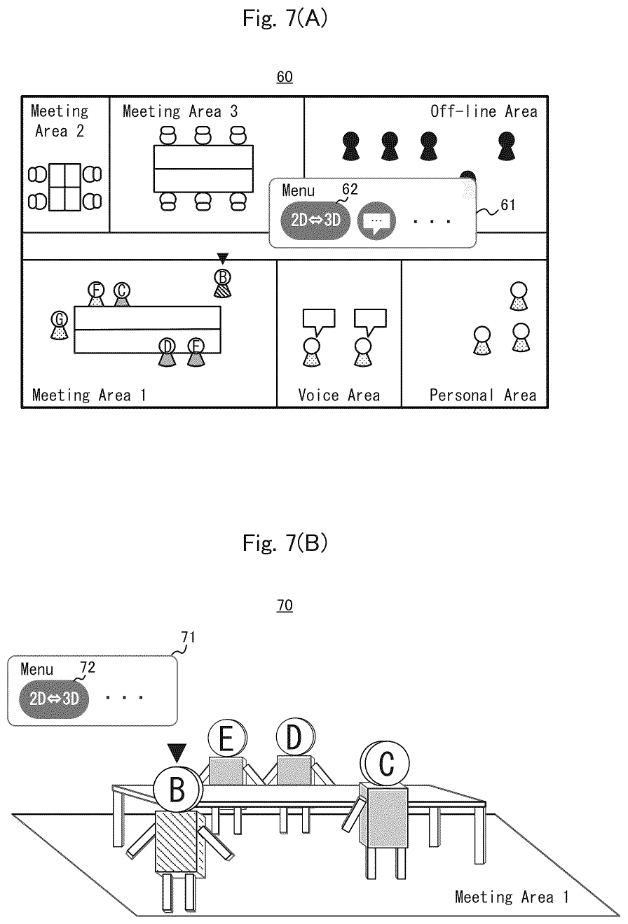

FIG. 7(A) and 7(B) illustrate display examples of the virtual office transmitted by the server 10a.

FIG. 7(A) is an example of display of the two-dimensional virtual office. A virtual office 60 in FIG. 7(A) includes a menu area 61 and a switch icon 62. In the menu area 61, icons for executing functions of the virtual office are displayed. The switch icon 62 is an icon for switching display of the virtual office. A user can switch the display from the two-dimensional virtual office to the three-dimensional virtual office by pressing the switch icon 62.

Avatars B to G are displayed in “Meeting Area 1” in FIG. 7(A). It is assumed that the avatars B to E are avatars of users belonging to a sales department, and the avatars G and F are avatars of users belonging to another department. It is assumed that the avatar B and the avatars belonging to the same department as the avatar B are selected as the three-dimensional avatars.

Now, it is assumed that the user related to the avatar B presses the switch icon 62. As a result, a three-dimensional virtual office as illustrated in FIG. 7(B) is displayed on the terminal device 20 of the user related to the avatar B.

FIG. 7(B) is an example of display of the three-dimensional virtual office. A virtual office 70 in FIG. 7(B) includes a menu area 71 and a switch icon 72. A user can switch the display from the three-dimensional virtual office to the two-dimensional virtual office by pressing the switch icon 72. In FIG. 7(B), the avatars B to E and a virtual object are three-dimensionally displayed in the virtual office 70.

In this manner, in the second example embodiment, the user can switch the display of the virtual office at an optional timing. By narrowing down the avatars to be displayed, consumption of computer resources can be suppressed.

### Metaverse Space Control Processing

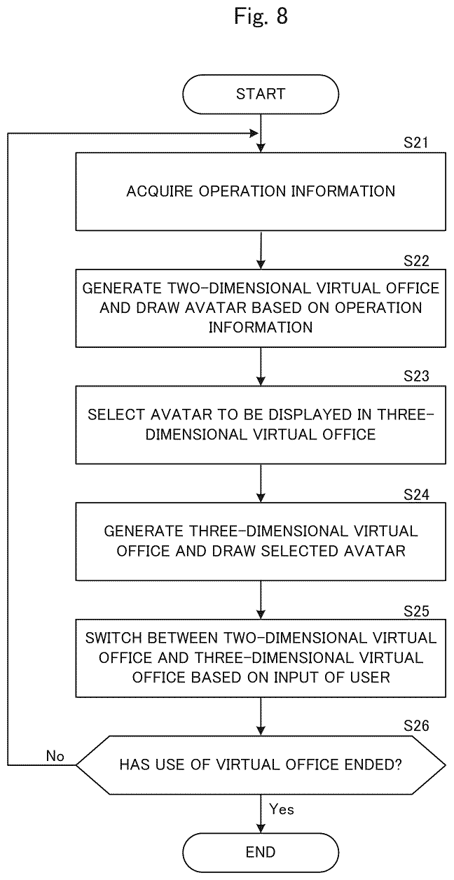

Next, metaverse space control processing of controlling a metaverse space as described above will be described. FIG. 8 is a flowchart of the metaverse space control processing by the server 10a. This processing is achieved by the processor 12 illustrated in FIG. 2 executing a program prepared in advance and operating as each element illustrated in FIG. 6.

The processing in steps S22 and S26 is similar to the processing in steps S12 and S16 of the first example embodiment illustrated in FIG. 5, and thus description thereof will be omitted.

First, the server 10a receives operation information from the terminal device 20 through the communication unit 11. The acquisition unit 111a acquires the operation information for each user, and outputs the operation information to the two-dimensional space display control unit 112a, the three-dimensional space display control unit 113a, and the selection unit 114a (step S21).

Next, the selection unit 114a selects a three-dimensional avatar, and outputs identification information regarding the three-dimensional avatar to the three-dimensional space display control unit 113a (step S23). Next, the three-dimensional space display control unit 113a generates a three-dimensional virtual office. The three-dimensional space display control unit 113a draws an avatar based on the operation information input from the acquisition unit 111a and the identification information regarding the three-dimensional avatar input from the selection unit 114a (step S24). Next, the control unit 115a switches between the two-dimensional space display control unit 112a and the three-dimensional space display control unit 113a based on an input of a user (step S25).

### Third Example Embodiment

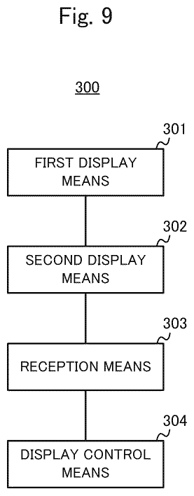

FIG. 9 is a block diagram illustrating a functional configuration of a metaverse space display device of a third example embodiment. A metaverse space display device 300 includes first display means 301, second display means 302, reception means 303, and display control means 304.

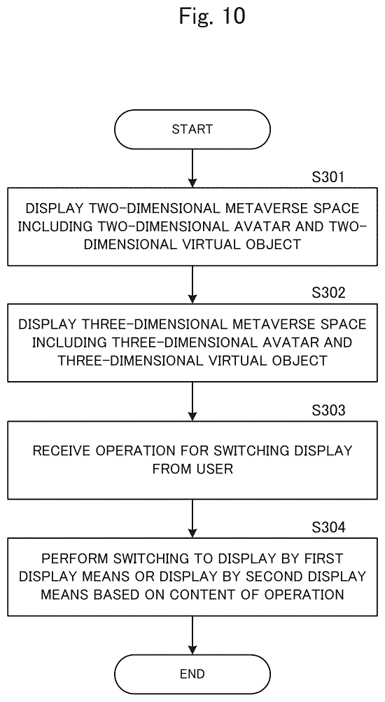

FIG. 10 is a flowchart of processing by the metaverse space display device of the third example embodiment. The first display means 301 displays a two-dimensional metaverse space including a two-dimensional avatar and a two-dimensional virtual object (step S301). The second display means 302 displays a three-dimensional metaverse space including a three-dimensional avatar and a three-dimensional virtual object (step S302). The reception means 303 receives an operation from a user (step S303). The display control means 304 performs switching to the display by the first display means or the display by the second display means based on a content of the operation (step S304).

According to the metaverse space display device 300 of the third example embodiment, it is possible to appropriately allocate computer resources by performing display control of a metaverse space.

Some or all of the above example embodiments may also be described as the following Supplementary Notes, but are not limited to the following Supplementary Notes.

### Supplementary Note 1

A metaverse space display device comprising:
first display means for displaying a two-dimensional metaverse space including a two-dimensional avatar and a two-dimensional virtual object;
second display means for displaying a three-dimensional metaverse space including a three-dimensional avatar and a three-dimensional virtual object;
reception means for receiving an operation from a user; and
display control means for performing switching to the display by the first display means or the display by the second display means based on a content of the operation, the first display means displaying an avatar of a user who is not logged in to the metaverse space in a mode different from a mode of an avatar of a user who is logged in to the metaverse space.

### Supplementary Note 2

The metaverse space display device according to supplementary note 1, wherein the reception means receives an operation in which an avatar in the two-dimensional metaverse space enters the three-dimensional metaverse space or an operation in which an avatar in the three-dimensional metaverse space enters the two-dimensional metaverse space, and
the display control means performs switching to the display by the first display means or the display by the second display means according to the metaverse space in which the avatar has entered.
   Supplementary note 3

The metaverse space display device according to supplementary note 1, wherein the reception means receives an operation of selecting the two-dimensional metaverse space or an operation of selecting the three-dimensional metaverse space, and the display control means performs switching to the display by the first display means or the display by the second display means based on a content of the selection.

Supplementary note 4

The metaverse space display device according to supplementary note 3, wherein the second display means draws, on the three-dimensional metaverse space, some selected avatars among a plurality of avatars.

Supplementary note 5

The metaverse space display device according to supplementary note 1, further comprising
notification means for performing notification to the user who is not logged in to the metaverse space,
wherein, in a case where the avatar of the user who is logged in to the metaverse space makes an action on the avatar of the user who is not logged in to the metaverse space, the notification means performs the notification to the user who is not logged in to the metaverse space.

### Supplementary Note 6

A metaverse space display method comprising:
performing first display processing of displaying a two-dimensional metaverse space including a two-dimensional avatar and a two-dimensional virtual object;
performing second display processing of displaying a three-dimensional metaverse space including a three-dimensional avatar and a three-dimensional virtual object;
receiving an operation from a user; and
performing switching to the display by the first display processing or the display by the second display processing based on a content of the operation,
an avatar of a user who is not logged in to the metaverse space being displayed in the first display processing in a mode different from a mode of an avatar of a user who is logged in to the metaverse space.

### Supplementary Note 7

A recording medium recording a program for causing a computer to execute processing comprising:
performing first display processing of displaying a two-dimensional metaverse space including a two-dimensional avatar and a two-dimensional virtual object;
performing second display processing of displaying a three-dimensional metaverse space including a three-dimensional avatar and a three-dimensional virtual object;
receiving an operation from a user; and
performing switching to the display by the first display processing or the display by the second display processing based on a content of the operation,
an avatar of a user who is not logged in to the metaverse space being displayed in the first display processing in a mode different from a mode of an avatar of a user who is logged in to the metaverse space.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

1 Metaverse space management system
10, 10a Server
15 Database (DB)
20 Terminal device
111, 111a Acquisition unit
112, 112a Two-dimensional space display control unit
113, 113a Three-dimensional space display control unit
114 Avatar state estimation unit
114a Selection unit
115, 115a Control unit
116, 116a Output unit

What is claimed is:

1. A metaverse space display device comprising:
at least one memory configured to store instructions; and
at least one processor configured to execute the instructions to:
display a two-dimensional metaverse space including a two-dimensional avatar and a two-dimensional virtual object;
display a three-dimensional metaverse space including a three-dimensional avatar and a three-dimensional virtual object;
receive an operation from a user; and
perform switching to the display by the first display means or the display by the second display means based on a content of the operation,
the one or more processors display an avatar of a user who is not logged in to the metaverse space in a mode different from a mode of an avatar of a user who is logged in to the metaverse space.

2. The metaverse space display device according to claim 1, wherein
the one or more processors receive an operation in which an avatar in the two-dimensional metaverse space enters the three-dimensional metaverse space or an operation in which an avatar in the three-dimensional metaverse space enters the two-dimensional metaverse space, and
the one or more processors perform switching to the two-dimensional metaverse space or the three-dimensional metaverse space according to the metaverse space in which the avatar has entered.

3. The metaverse space display device according to claim 1, wherein
the one or more processors receive an operation of selecting the two-dimensional metaverse space or an operation of selecting the three-dimensional metaverse space, and
the one or more processors perform switching to the two-dimensional metaverse space or the the three-dimensional metaverse space based on a content of the selection.

4. The metaverse space display device according to claim 3, wherein the one or more processors draw, on the three-dimensional metaverse space, some selected avatars among a plurality of avatars.

5. The metaverse space display device according to claim 1,
wherein the one or more processors perform notification to the user who is not logged in to the metaverse space,
wherein, in a case where the avatar of the user who is logged in to the metaverse space makes an action on the avatar of the user who is not logged in to the metaverse space, the one or more processors perform the notification to the user who is not logged in to the metaverse space.

6. A metaverse space display method comprising:
performing first display processing of displaying a two-dimensional metaverse space including a two-dimensional avatar and a two-dimensional virtual object;
performing second display processing of displaying a three-dimensional metaverse space including a three-dimensional avatar and a three-dimensional virtual object;
receiving an operation from a user; and
performing switching to the display by the first display processing or the display by the second display processing based on a content of the operation,
an avatar of a user who is not logged in to the metaverse space being displayed in the first display processing in a mode different from a mode of an avatar of a user who is logged in to the metaverse space.

7. A non-transitory computer readable recording medium recording a program for causing a computer to execute processing comprising:
performing first display processing of displaying a two-dimensional metaverse space including a two-dimensional avatar and a two-dimensional virtual object;
performing second display processing of displaying a three-dimensional metaverse space including a three-dimensional avatar and a three-dimensional virtual object;
receiving an operation from a user; and
performing switching to the display by the first display processing or the display by the second display processing based on a content of the operation,
an avatar of a user who is not logged in to the metaverse space being displayed in the first display processing in a mode different from a mode of an avatar of a user who is logged in to the metaverse space.
